(19) United States
(12) Patent Application Publication
(10) Pub. No.: US 2003/0215370 A1
(43) Pub. Date: Nov. 20, 2003

(54) Test tube holding adapter

(76) Inventor: Teruaki Itoh, Kumamoto-shi (JP)

Correspondence Address: NIXON & VANDERHYE, PC, 1100 N GLEBE ROAD, 8TH FLOOR, ARLINGTON, VA, 22201-4714, US

(21) Appl. No.: 10/434,114

(22) Filed: May 9, 2003

(30) Foreign Application Priority Data
May 14, 2002 (JP) 2002-138716

(51) Int. Cl. B01L 9/00

(52) U.S. Cl. 422/104

(57) ABSTRACT

A test tube holding adapter is fitted in a test tube holder and provided to selectively hold test tubes having different outside diameters. The adapter includes a flange section, an annular section, and a plurality of flat spring sections whose proximal end portions are connected to the annular section and whose distal end portions extend inward through the opening and bend toward the axis of the adapter such that the adapter is shaped like a funnel as a whole. The annular section includes a fitting portion fitted at given pressure to one of concave and convex portions formed on the inner surface of the opening.

### CROSS-REFERENCE TO RELATED APPLICATIONS

This application is based upon and claims the benefit of priority from the prior Japanese Patent Application No. 2002-138716, filed May 14, 2002, the entire contents of which are incorporated herein by reference.

### BACKGROUND OF THE INVENTION

1. Field of the Invention

The present invention relates to a test tube holding adapter that is inserted into a test tube holding opening of a test tube holder and capable of selectively holding test tubes having different outside diameters.

2. Description of the Related Art

Some prior art test tube holding adapters are almost cylindrical as a whole and each have an annular section, which is fitted into a test tube holding opening of a test tube holder, at one end and a plurality of flat spring sections, which are arranged like a funnel so as to selectively hold test tubes having different outside diameters, at the other end.

The annular section is formed with very high precision in outer dimensions such that its outer surface is closely fitted on the inner surface of the test tube holding opening of the test tube holder.

The above-described prior art test tube holding adapters are so designed that the outer dimensions of the annular section exactly coincide with the inner dimensions of the test tube holding opening of a specific test tube holder. However, there are a variety of test tube holders such as a conveying test tube holder called a columnar rack, a keeping test tube holder for stocking and keeping a test tube and a centrifuging test tube holder used for centrifuging a test tube containing a specimen such as blood. If, therefore, the above adapter is inserted into the test tube holding opening of a different type of test tube holder, the following problem occurs. The adapter cannot be inserted because of different sizes and the inserted adapter in use easily comes out.

### BRIEF SUMMARY OF THE INVENTION

An object of the present invention is to provide a test tube holding adapter that is applicable to a plurality of types of test tube holders in common and with stability.

In order to attain the above object, a test tube holding adapter according to the present invention has the following characteristic configuration. The other characteristic configurations will be clarified in the embodiments later.

A test tube holding adapter which is fitted in a test tube holding opening of a test tube holder and provided to selectively hold test tubes having different outside diameters,

the test tube holding adapter comprising a flange section which contacts an end face of the opening of the test tube holder, an annular section one end of which ranges with an inner circumference of the flange section and which is fitted on an inner surface of the opening, and a plurality of flat spring sections whose proximal end portions are arranged at regular intervals in the circumferential direction of the annular section and connected to another end of the annular section and whose distal end portions extend inward through the opening and bend toward an axis of the adapter such that the adapter is shaped like a funnel as a whole,

wherein the annular section includes a fitting portion which is fitted at given pressure to one of a concave portion and a convex portion formed on the inner surface of the opening when the annular section is fitted to the inner surface of the opening.

In the test tube holding adapter described above, the fitting portion formed on the outer surface of the annular section is fitted at given pressure to one of the concave and convex portions formed on the inner surface of the opening of the test tube holder. Therefore, even though there is a difference between the inside diameter of the opening and the outside diameter of the annular section, the test tube holding adapter can firmly and stably be fitted to the test tube holder.

### BRIEF DESCRIPTION OF THE SEVERAL VIEWS OF THE DRAWING

FIG. 1 is a perspective view schematically showing a configuration of a test tube holding adapter according to a first embodiment of the present invention, which is applied to a conveying test tube holder;

FIG. 2A is a top view showing a correlation between the test tube holding adapter according to the first embodiment of the present invention and the conveying test tube holder in which the test tube holding adapter is fitted;

FIG. 2B is a cross-sectional view taken along line 2B-2B of FIG. 2A and showing a correlation between the test tube holding adapter according to the first embodiment of the present invention and the conveying test tube holder;

FIG. 3 is an external, perspective view showing a configuration of the test tube holding adapter according to the first embodiment of the present invention;

FIG. 4 is a cross-sectional view showing a main part of the test tube holding adapter according to the first embodiment of the present invention to describe the function of the test tube holding adapter;

FIG. 5 is a top view of the arrangement of test tube holding adapters according to a second embodiment of the present invention, which are applied to a keeping test tube holder;

FIG. 6 is an enlarged cross-sectional view of the main part of each of the test tube holding adapters according to the second embodiment of the present invention, which are applied to a keeping test tube holder;

FIG. 7 is a side view of a test tube holding adapter according to a third embodiment of the present invention, which is applied to a centrifuging test tube holder; and

FIG. 8 is an enlarged cross-sectional view of the main part of the test tube holding adapter according to the third embodiment of the present invention, which is applied to a centrifuging test tube holder.

### DETAILED DESCRIPTION OF THE INVENTION

(First Embodiment)

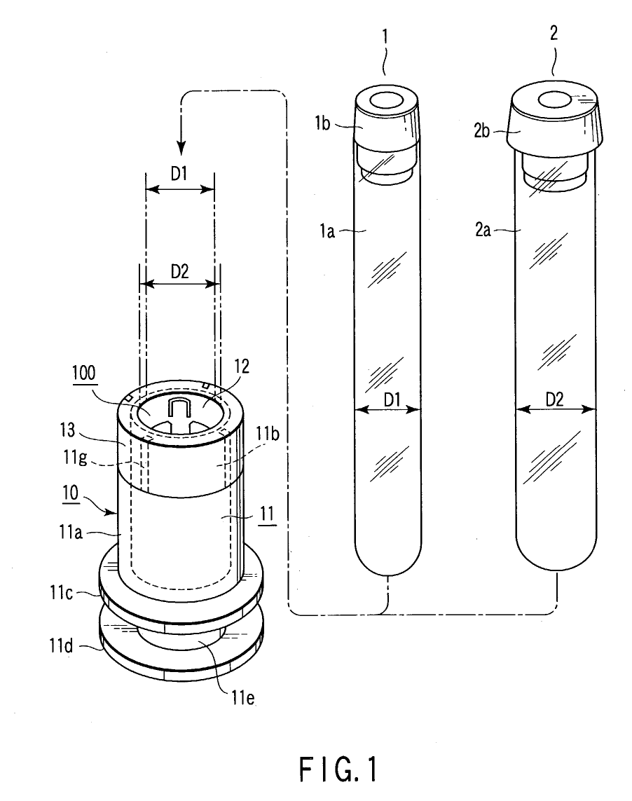

FIG. 1 is a perspective view schematically showing a configuration of a test tube holding adapter 100 according to a first embodiment of the present invention, which is applied to a conveying test tube holder 10.

The conveying test tube holder 10 shown in FIG. 1 has two flange sections 11c and 11d, which are to be engaged with conveying guide rails (not shown), on the outer surface of a proximal end portion of a cylindrical base body 11 that is made of, e.g., synthetic resin. The two flange sections 11c and 11d prevent the test tube holder 10 from toppling due to vibrations or the like during the conveyance of the test tube holder 10. These flange sections can be engaged with, e.g., guide rails (not shown) arranged on both sides of a belt conveyer (not shown).

An annular groove lie is formed between the two flange sections 11c and 11d. A stopping pin of a piston/cylinder device (not shown) for controlling the conveyance of the conveying test tube holder 10 can be inserted in the annular groove lie to stop the test tube holder 10 in a specific position of the belt conveyor.

The cylindrical base body 11 has a large-diameter section 11a on its middle part in the longitudinal direction and a small-diameter section 11b that ranges with the large-diameter section 11a and corresponds to the distal end portion of the cylindrical base body 11. A plurality of slits 11g (four slits in this embodiment) are formed in the outer surface of the small-diameter section 11b in parallel along the longitudinal direction of the base body 11. A metallic fastening ring 13, which serves as an indicator for detecting the presence of the holder by a photodetector or the like, is fitted on the outer surface of the small-diameter section 11b.

A test tube holding opening 12 is formed along the axis of the cylindrical base body 11 to a given depth, e.g., the depth corresponding to the position of the flange section 11c, from the top (upper end in FIG. 1) of the cylindrical base body 11 to the bottom (lower end in FIG. 1) thereof.

The test tube holding adapter 100 is fitted into the opening 12. The adapter 100 selectively and stably holds a plurality of types of test tubes 1 and 2 having different outside diameters D1 and D2 when the test tubes 1 and 2 are inserted. The upper openings of tube bodies 1a and 2a of the test tubes 1 and 2 are closed with caps 1b and 2b, respectively.

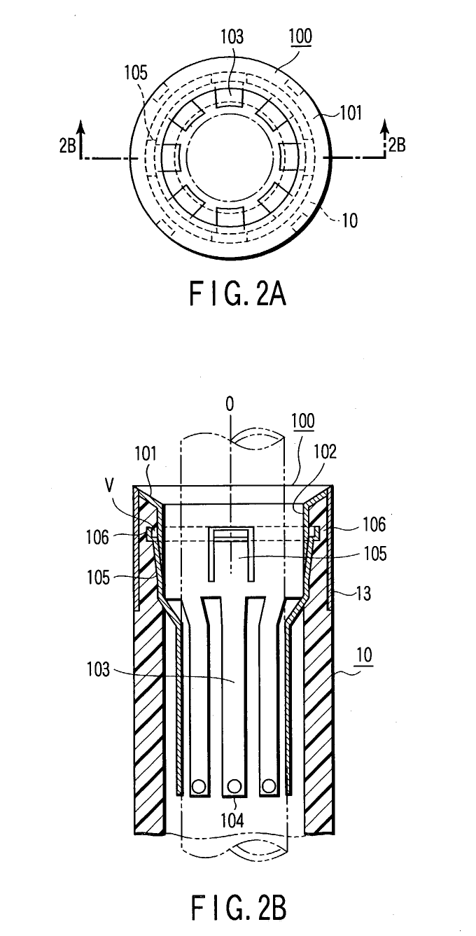

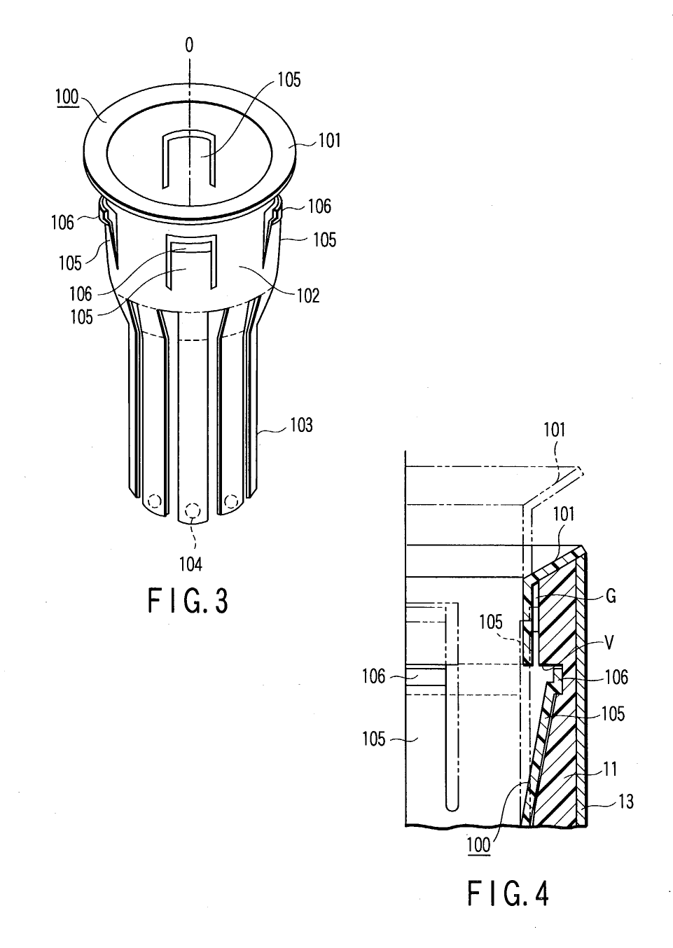

FIG. 2A is a top view showing a correlation between the test tube holding adapter 100 and the conveying test tube holder 10 in which the test tube holding adapter 100 is fitted. FIG. 2B is a cross-sectional view taken along line 2B-2B of FIG. 2A. FIG. 3 is an external, perspective view showing a configuration of the test tube holding adapter 100.

As shown in FIGS. 2A, 2B and 3, the test tube holding adapter 100 is formed integrally using an elastic member such as synthetic resin. More specifically, the test tube holding adapter 100 includes a flange section 101, an annular section 102 and a plurality of flat spring sections 103. The flange section 101 contacts the end face of the opening 12 of the test tube holder 10. The annular section 102 ranges with the inner circumference of the flange section 101 and is fitted on the inner surface of the opening 12. The proximal end portions of the flat spring sections 23 are arranged at regular intervals along the circumference of the annular section 102 and connected to the annular section 102, and the distal end portions thereof extend inward through the opening 12 and bend toward the axis O of the adapter 100 such that the adapter 100 is shaped like a funnel as a whole.

A holding section 104 of a hemispherical projection is formed on the inner surface of the distal end portion of each of the flat spring sections 103. The holding section 104 contacts the outer surfaces of the test tubes 1 and 2 and stably holds the test tubes 1 and 2.

A plurality of contact pieces 105 serving as fitting portions are arranged on the outer wall of the annular section 102 in the circumferential direction. The contact pieces 105 are formed by cutting, raising and processing the outer wall of the annular section 102. When the annular section 102 is fitted on the inner surface of the opening 12 of the test tube holder 10, at least the end portions of the contact pieces 105 are fitted and compressed into a concave portion V formed in the inner surface of the opening 12. The contact pieces 105 are gradually bent away from the axis of the adapter in the upward direction. A projection 106 is formed on the outer surface of a distal end portion of each of the contact pieces 105 and falls into the concave portion V.

Referring to FIG. 4 appropriately, the function of the above test tube holding adapter according to the first embodiment will now be described. The test tube holding adapter 100 is inserted into the opening 12 of the holder 10 in order to fit the test tube holding adapter 100 in the conveying test tube holder 10. Thus, the annular section 102 is fitted in the opening 12 and the flange section 101 contacts the end face of the opening 12. Then, the contact pieces 105 formed on the outer surface of the annular section 102 slide into the opening 12 of the test tube holder 10 from the end face of the opening 12 as indicated by broken lines in FIG. 4. The projection 106 slides to the position of the concave portion V formed in the inner surface of the opening 12 while being displaced and compressed in the axial direction. When the projection 106 slides to the position of the concave portion V, it falls into the concave portion V at given pressure by the restoring force of the contact piece 105. In other words, the distal end portions of the contact pieces 105 are fitted and compressed into the concave portion V. Thus, the adapter 100 is elastically supported on the inner surface of the opening of the test tube holder 10 by the spring force of each of the contact pieces 105. Consequently, the test tube holding adapter 100 is stably held in the axial position of the opening 12 of the test tube holder 10.

Even though there is a slight gap G between the inner surface of the opening 12 of the test tube holder 10 and the outer surface of the annular section 102 of the adapter 100, the adapter 100 is firmly and stably fitted to the test tube holder 10. When the adapter is fitted to the test tube holder as described above, a so-called stop function is performed by a relationship between the concave portion V and the contact pieces 105 that are gradually bent away from the axis in the upward direction, with the result that the adapter 100 is prevented from coming out of the opening 12 of the test tube holder 10.

When the test tube 1 having a relatively small outside diameter D1 is inserted into the test tube holder 10 with the test tube holding adapter 100, all of holding sections 104 of the adapter 100 are brought into contact with the outer surface of the test tube 1 and the distal end portions of the flat spring sections 103 are slightly expanded in accordance with the outside diameter of the test tube 1. The outer surface of the test tube 1 is therefore held in an axial position of the holder 10 at given pressure by means of the holding sections 104. Consequently, the test tube 1 is stably supported at two locations where the holding sections 104 are present and where the test tube contacts the bottom of the holder (not shown).

When the test tube 2 having a relatively large outside diameter D2 is inserted into the test tube holder 10, the holding sections 104 of the adapter 100 are brought into contact with the outer surface of the test tube 2 and the distal end portions of the flat spring sections 103 are greatly expanded. The holding sections 104 therefore hold test tube 2 in an axial position of the holder 10 at the pressure that is slightly greater than the above pressure. Consequently, the test tube 2 is stably supported at two locations where the holding sections 104 are present and where the test tube contacts the bottom of the holder (not shown).

(Second Embodiment)

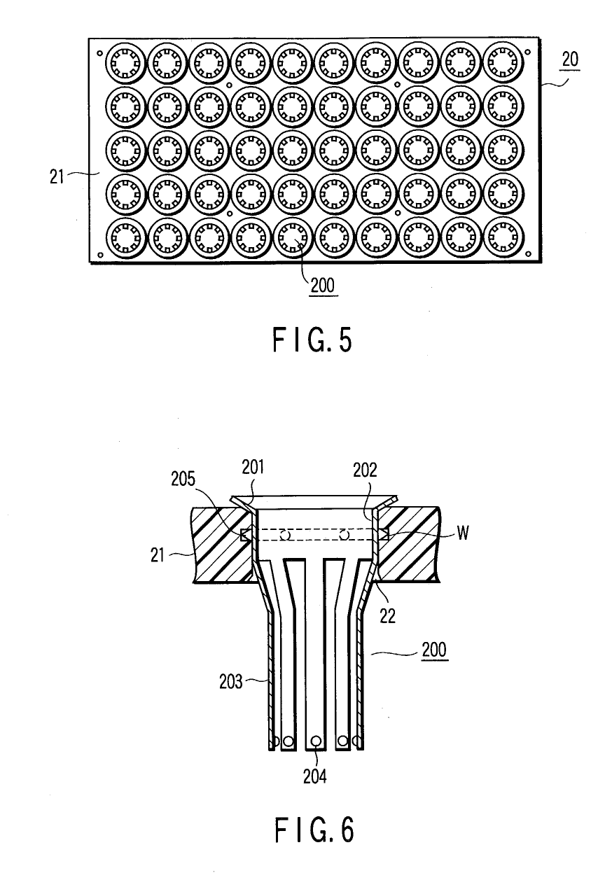

FIG. 5 is a top view of the arrangement of test tube holding adapters 200 according to a second embodiment of the present invention, which are applied to a keeping test tube holder 20. FIG. 6 is a cross-sectional view of the structure of the main part of each of the test tube holding adapters 200.

Each of the test tube holding adapters 200 of the second embodiment, shown in FIG. 5 and FIG. 6, differs from that of the first embodiment in that a plurality of conical or hemispherical projections 205 are formed on the outer surface of an annular section 202 as fitting portions of the adapter 200.

In the test tube holding adapter 200 described above, the conical or hemispherical projections 205 are moderately elastic and thus fitted, at given pressure, into an annular groove W formed in the inner surface of an opening 22 formed in an upper plate 21 of the test tube holder 20. Consequently, even though there is a slight gap between the inner surface of the opening 22 of the test tube holder 20 and the outer surface of the annular section 202 of the adapter 200, the adapter 200 is firmly and stably fitted to the opening 22 of the test tube holder 20.

In FIG. 6, reference numeral 201 indicates a flange section, 203 shows a plurality of flat spring sections and 204 denotes a test tube holding section. Since the test tube holding adapter 200 of the second embodiment is simpler in structure than that of the first embodiment, it is advantageously easy to manufacture. The other components are basically the same as those of the first embodiment and thus their descriptions are omitted.

(Third Embodiment)

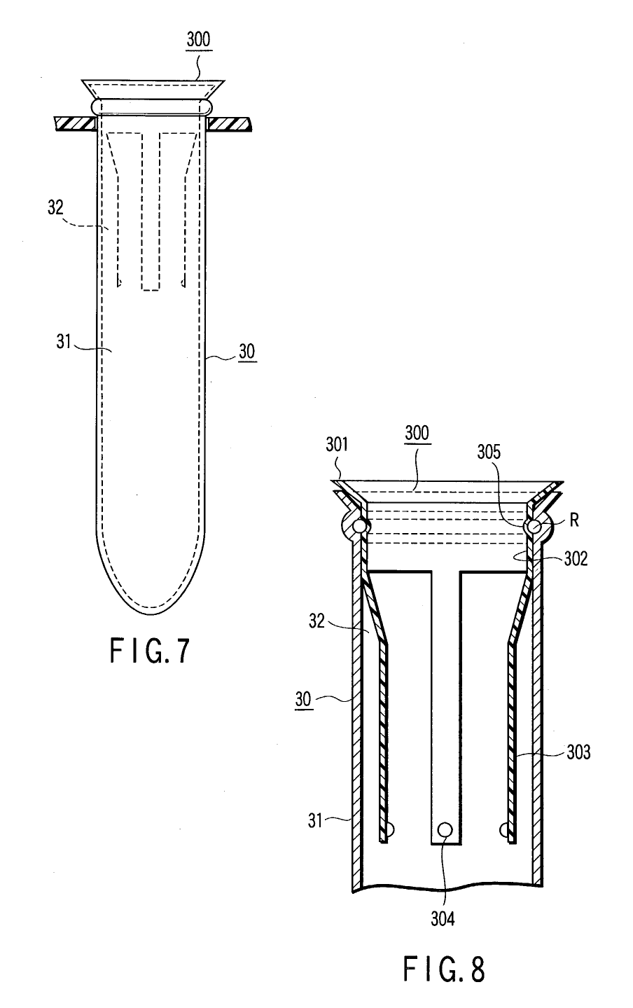

FIG. 7 is a side view of a test tube holding adapter 300 according to a third embodiment of the present invention, which is applied to a centrifuging test tube holder 30 (including an aluminum tube 31). FIG. 8 is an enlarged cross-sectional view of the main part of the adapter shown in FIG. 7.

The test tube holding adapter 300 of the third embodiment, shown in FIG. 7 and FIG. 8, differs from that of the first embodiment in that an O-ring fitting annular groove 305 is formed in the outer surface of an annular section 302 as a fitting portion of the adapter 300.

In the test tube holding adapter 300 described above, an O-ring R formed on the inner surface of the aluminum tube 31 of the centrifuging test tube holder 30 is fitted, at given pressure, into the annular groove 305 formed in the outer surface of the annular section 302. Consequently, even though there is a slight gap between the inner surface of the aluminum tube 31 and the outer surface of the annular section 302 of the adapter 300, the adapter 300 is firmly and stably fitted to the inner surface of the aluminum tube 31. Since the test tube holding adapter 300 of the third embodiment is simpler in structure than that of the first embodiment, it is advantageously easy to manufacture.

In FIG. 8, reference numeral 301 indicates a flange section, 303 shows a plurality of flat spring sections and 304 denotes a test tube holding section. The other components are basically the same as those of the first embodiment and thus their descriptions are omitted.

(Features of the Embodiments)

[1] A test tube holding adapter according to an embodiment, which is a test tube holding adapter (100, 200, 300) fitted in a test tube holding opening (12, 22, 32) of a test tube holder (10, 20, 30) and provided to selectively hold test tubes (1, 2) having different outside diameters, the test tube holding adapter comprising a flange section (101, 201, 301) which contacts the end face of the opening (12, 22, 32), an annular section (102, 202, 302) one end of which ranges with the inner circumference of the flange section (101, 201, 301) and which is fitted on the inner surface of the opening (12, 22, 32), and a plurality of flat spring sections (103, 203, 303) whose proximal end portions are arranged at regular intervals in the circumferential direction of the annular section (102, 202, 302) and connected to the other end of the annular section (102, 202, 302) and whose distal end portions extend inward through the opening (12, 22, 32) and bend toward the axis O of the adapter such that the adapter is shaped like a funnel as a whole,

wherein the annular section (102, 202, 302) includes a fitting portion (105, 205, 305) which is fitted at given pressure to one of a concave portion (V, W) and a convex portion (R) formed on the inner surface of the opening (12, 22, 32) when the annular section (102, 202, 302) is fitted to the inner surface of the opening (12, 22, 32).

In the test tube holding adapter (100, 200, 300) described above, the fitting portion (105, 205, 305) of the annular section (102, 202, 302) is fitted at given pressure to one of the concave portion (V, W) and the convex portion (R) formed on the inner surface of the opening (12, 22, 32). Therefore, the adapter (100, 200, 300) can firmly and stably be fitted to the test tube holder (10, 20, 30) even though there is a slight gap G between the inner surface of the opening (12, 22, 32) of the test tube holder (10, 20, 30) and the outer surface of the annular section (102, 202, 302) of the adapter (100, 200, 300).

[2] The test tube holding adapter 100 according to the above item [1], wherein the fitting portion 105 is a contact piece 105 which bents away from the axis of the adapter in the upward direction along the outer surface of the annular section 102 such that at least the end portion of the contact piece is fitted into the concave portion V formed in the inner surface of the opening 12 when the annular section 102 is fitted to the inner surface of the opening 12.

In the test tube holding adapter 100, the end portion of the contact piece 105 which bents away from the axis of the adapter is fitted into the concave portion V at given pressure. Therefore, the adapter can firmly and stably be fitted to the test tube holder 10 even though there is a slight gap G between the inner surface of the opening 12 of the test tube holder 10 and the outer surface of the annular section 102 of the adapter 100. Moreover, when the adapter is fitted to the test tube holder, a stop function is performed by the fitting between the concave portion V and the contact piece 105, with the result that the adapter 100 can be prevented from coming out of the opening 12 of the test tube holder 10.

[3] The test tube holding adapter 100 according to the above item [2], wherein a projection 106 is formed on an outer surface of the distal end portion of the contact piece 105 and fitted into the concave portion V.

In the test tube holding adapter 100, the projection 106 falls into the concave portion V, with the result that the contact piece 105 is fitted into the concave portion V with higher reliability and thus a stable fitting condition is achieved.

[4] The test tube holding adapter (100, 200, 300) according to one of the above items [1], [2] and [3], wherein the flange section (101, 201, 301), the annular section (102, 202, 302), the flat spring sections (103, 203, 303) and the fitting portion (105, 205, 305) are formed integrally as one component using an elastic member such as synthetic resin.

In the test tube holding adapter (100, 200, 300), the integral formation simplifies the manufacturing process and thus decreases the manufacturing costs.

(Modifications)

The test tube holding adapter according to the above embodiments can be modified as follows:

The test tube holding adapters 100, 200 and 300 can be formed of an elastic metal member other than synthetic resin, such as phosphor bronze.

The test tube holding adapters 100 according to the first embodiment can be formed such that it can be applied to the keeping test tube holder 20 and the centrifuging test tube holder 30.

What is claimed is:

1. A test tube holding adapter which is fitted in a test tube holding opening of a test tube holder and provided to selectively hold test tubes having different outside diameters,
the test tube holding adapter comprising a flange section which contacts an end face of the opening of the test tube holder, an annular section one end of which ranges with an inner circumference of the flange section and which is fitted on an inner surface of the opening, and a plurality of flat spring sections whose proximal end portions are arranged at regular intervals in the circumferential direction of the annular section and connected to another end of the annular section and whose distal end portions extend inward through the opening and bend toward an axis of the adapter such that the adapter is shaped like a funnel as a whole,
wherein the annular section includes a fitting portion which is fitted at given pressure to one of a concave portion and a convex portion formed on the inner surface of the opening when the annular section is fitted to the inner surface of the opening.

2. The test tube holding adapter according to claim 1, wherein the fitting portion is a contact piece which bents away from the axis of the adapter in an upward direction along an outer surface of the annular section such that at least an end portion of the contact piece is fitted into the concave portion formed in the inner surface of the opening when the annular section is fitted to the inner surface of the opening.

3. The test tube holding adapter according to claim 2, wherein a projection is formed on an outer surface of the distal end portion of the contact piece and fitted into the concave portion.

4. The test tube holding adapter according to claim 1, wherein the flange section, the annular section, the flat spring sections and the fitting portion are formed integrally as one component using an elastic member such as synthetic resin.

5. The test tube holding adapter according to claim 2, wherein the flange section, the annular section, the flat spring sections and the fitting portion are formed integrally as one component using an elastic member such as synthetic resin.

6. The test tube holding adapter according to claim 3, wherein the flange section, the annular section, the flat spring sections and the fitting portion are formed integrally as one component using an elastic member such as synthetic resin.
